(19) United States
(12) Patent Application Publication
(10) Pub. No.: US 2013/0103423 A1
(43) Pub. Date: Apr. 25, 2013

(54) COOPERATIVE MEDICAL CONSULTATION AND DIAGNOSIS SYSTEM AND A METHOD THEREFOR

(71) Applicant: Kwan Hyoung Kim, SEOUL (KR)

(72) Inventor: Kwan Hyoung Kim, SEOUL (KR)

(21) Appl. No.: 13/582,652

(22) PCT Filed: Mar. 3, 2011
(86) PCT No.: PCT/KR11/01475

§ 371 Date: Sep. 4, 2012

(30) Foreign Application Priority Data
Mar. 4, 2010 (KR) 10-2010-0019407

(51) Int. Cl. G06F 19/00

(52) U.S. Cl. CPC G06F 19/3425
USPC 705/3

(57) ABSTRACT

This invention relates to a system for medical treatment with consultation (the consultation system) and its method, designed to support several physicians located at different place and time to access the system at a designated time, share medical records on a patient and conduct medical treatment with consultation. To this end, this invention comprises the following stages: receiving a consultation request from at least one of the hospital terminals, physician terminals, and patient terminals; selecting at least more than one consulting physicians to participate in the consultation according to the said consultation request; receiving the medical records of a patient subject to said consultation from at least one of the hospital servers, hospital terminals, physician terminals, or patient terminals, providing the medical records to the consulting physicians, and conducting consultation pursuant to the registered consultation schedule by controlling communications among the said hospital terminals, physician terminals, and patient terminals; and transmitting the consultation progress information including the consultation schedule, consulting opinions received from the consulting physicians, and consultation data registered according to the consulting opinions to at least one of the hospital terminals, physician terminals, and patient terminals.

### CROSS REFERENCE TO RELATED APPLICATIONS

This application is a National Phase application, filed under 35 U.S.C. §371, of PCT Application No. PCT/KR2011/001475, filed Mar. 3, 2011, which claims the benefit of priority to Korean Patent Application No. 10-2010-0019407, filed Mar. 4, 2010, the contents of which are incorporated herein by reference herein in their entirety.

### BACKGROUND OF THE INVENTION

1. Field of the Invention

This invention relates to a medical system for diagnosis and treatment of patient and its method; especially to a system and its method to allow a number of physicians diagnose and treat patients through consultation.

2. Background of the Related Art

Everybody has to visit a hospital owing to various diseases or other causes whether they are serious or mild. In some cases, such processes may go with the flow based on opinions of a few physicians, but there are also cases which require gathering of diverse medical specialists to discuss the cases.

In such a case, each specialist has to work according to his own schedule, so it is not easy to gather all the necessary persons in a place to discuss a case; in reality, it is almost impossible. Even if they may ask questions and answer them through written documents, there can be troubles in communication which also takes time to send/receive opinions of each other. This is a factor recognized by most physicians working at clinical sites.

### SUMMARY OF THE INVENTION

The objective of this invention to solve the above-mentioned issues is for physicians located at different places and time zones to share medical records on patients and conduct medical treatment with consultation based on a system facilitating medical treatment with consultation and its method.

This invention designed to attain the said objective is made of the following stages: A stage in which the system of medical treatment with consultation receives a consultation request from any of hospital terminals, physician terminals, or patient terminals; A stage in which at least one consulting physician will be selected to participate in a consultation occurred pursuant to the said consultation request; A stage in which medical records of the said patient will be received from at least one of the above-mentioned hospital terminals, physician terminals, and patient terminals, and then a consultation is conducted by controlling communications between the said hospital terminals, physician terminals, and/or patient terminals pursuant to a schedule registered for the consultation; and a stage in which a consultation progress information including consultation records registered following the said consultant's opinion will be sent to any of the said hospital terminals, physician terminals, and patient terminals by the said consulting physician according to the said consultation schedule.

Expected effects of this invention are as follows: It will share medical information on a patient among many physicians located in different places and time while conducting medical treatment with consultation; In this way, it will allow each physician utilize his own office hours more efficiently; and it will enhance efficiency of medical services to patients. That is, this invention will allow any physicians requested to engage in a consultation share medical records and results of diagnosis/treatment which can be displayed on a terminal of each consulting physician through videos with sound or real-time relay regardless of his location at the time. In this way, many consulting physicians can exchange opinions each other and make plans for diagnosis, treatment, etc., based on diverse opinions of many specialists gathered by the requesting physician. On the other hand, each consulting physician can save time to be wasted owing to participation of numerous meetings, while providing higher quality medical services to patients.

In addition, this invention makes patients save time as there is no need to visit several hospitals to get proper medical treatments. As complete medical treatments with consultation will be possible online, they can get proper medical services based on their medical records without restraints of time or space and enjoy high quality medical services without time constraints.

Furthermore, when using this invention, there is no need for a patient to reserve a consultation or search a specialist directly or get repetitive treatments for the same symptom. A physician can provide medical services more effectively based on high quality consultation. A provincial government may build a high quality medical infrastructure of the region to save public medical expenses. As this invention can be implemented at any place by using existing equipment, it will save costs required to build such systems and can be implemented in no time compared to the other methods.

### BRIEF DESCRIPTION OF THE DRAWINGS

FIG. 1 shows a configuration diagram of a medical system applying this invention.

FIG. 2 shows an example of internal configuration of a consultation system based on this invention.

FIG. 3 shows several examples of data fields managed by a consultation system using this invention.

FIG. 4 shows an example of consultation participation in a system based on this invention.

FIG. 5 shows an implementation example of flow chart of a consultation method based on this invention.

FIG. 6 an implementation example of detailed flow of a process of receiving consultation requests based on this invention.

FIG. 7 shows an implementation example of detailed flow of a process of selecting physicians for medical treatment with consultation based on this invention.

FIG. 8 shows an implementation example of detailed flow of a consultation process based on this invention.

FIG. 9 shows an implementation example of detailed flow of a process of providing medical information based on this invention.

### DETAILED DESCRIPTION OF THE PREFERRED EMBODIMENT

The following are detailed description of the system for medical treatment with consultation and its methods by referring to the attached drawings. Prior to this, the following description is made for persons with average knowledge on the industry to understand the invention. This is not limited to the configuration described in the scope of implementation.

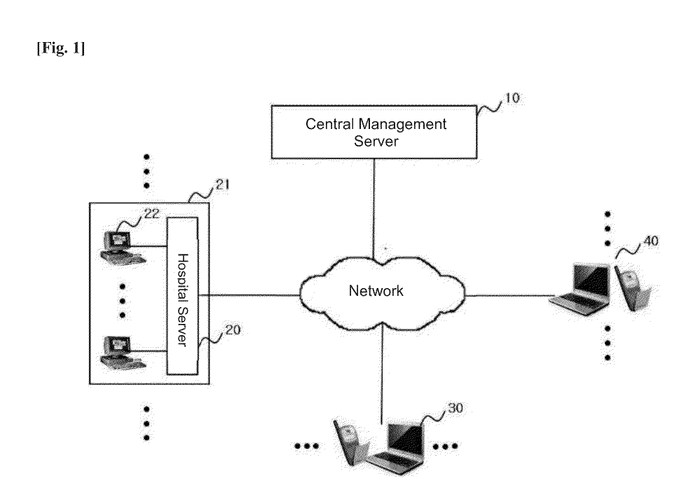

FIG. 1 shows a configuration diagram of a medical system applying this invention.

As shown in FIG. 1, the medical system will be made of the system for medical treatment with consultation 10 designed to provide services related to consultation; hospital terminals 22 installed at each hospital 21 for physicians in it; and many hospital servers 20 to communicate with the said system; physician terminals 30 used by physician to connect to the system from the outside; and patient terminals 40 used by patients to communicate with the system.

A physician terminal 30 is used by a physician to communicate with the system or hospital servers from the outside of the hospital. In here, a physician means any person who can assist medical care activities of a patient such as a medical specialist, an X-ray technician, a nurse practitioner, a physical therapist, a pharmacist, and a medical doctor, and managed by the system or hospital servers. A physician terminal means any devices which can communicate with others via network, including personal computer (PC), mobile terminal, and PDA. It may have a camera and a microphone to conduct video conference.

For hospital terminals 22 and patient terminals 40, diverse communications devices can be used and equipped with cameras and microphones

A hospital server 20 will be installed at each hospital 21, and communicate with any hospital terminal used by physicians in the hospital via its intranet. Its functions include management of information acquired via hospital terminals and provision of diverse information to hospital terminals. It will also communicate with the consultation system to implement the medical treatment with consultation based on this invention.

The system for medical treatment with consultation 10 will perform authentication process to clients. If an authentication is successful, then the system will receive a consultation request from the client, and analyze the received request, search eligible physicians to engage in the consultation (medical treatment with consultation; hereinafter referred to as the ‘consultation’), provide diverse information to the searched physicians. When approvals from the physicians are received, it will connect the client and the physicians concurrently pursuant to a preset schedule and share all relevant data to make them available to the consulting physicians.

At this time, it is desirable for the consultation system 10 to perform mapping of received patient/diagnosis information onto consulting physician data stored in database (storage unit). It is also possible to request participation in the consultation or provide diverse information concerning the consultation to e-mail addresses of physicians stored in it. In addition, the consultation system can notify each consulting physician to his hospital terminal (or physician terminal) of the acceptance of consultation by using his e-mail address/mobile phone number. In addition, the consultation system 10 can provide medical records, consultant's opinions or schedules/information on consultation, etc., via various means such as text message or e-mail by using hospital terminals, physician terminals, or patient terminals. At this time, text messages can be offered as one of the following formats: short message, long message and multimedia message. The consultation system 10 can receive medical records or consultation progress information via a hospital server, a hospital terminal 22 connected to the hospital server; it can also receive the data via a physician terminal 30 connected to the consultation system via network. If the consultation system 10 may be accessed via a hospital server, medical records and consultation progress information can be received through the hospital server. In the said case, the consultation system will also offer a separate subscription process to receive services made available by this invention after passing through authentication processes for consulting physicians who will diagnose patients after directly checking the client who requests the consultation or consultation progress information. If necessary, it is possible to set the level of information sending to the patient separately to differentiate the information provided to the consulting physician from that offered to the patient.

The consultation system 10 has diverse options in selecting physicians to be engaged in the consultation. That is, the consultation system can select consulting physicians among physicians in the area based on treatment options of a patient (which can be selected or entered by the patient), if physician data is not selected or entered by the patient. The consultation system is an example of selecting physicians to engage in the consultation. If there are data such as priority or popularity in the relevant treatment options, then the consultation system can select appropriate physicians to participate in the consultation based on such diverse information. Furthermore, if the system includes information such as the number of received requests for consultation, which of consultations actually participated in, consultant's opinions or satisfaction level on consultation information, then it can select appropriate physicians by taking such information into account additionally. The consultation system 10 can update medical records in the database (storage unit) whenever they are received by the client, and also update relevant consultation progress information whenever related data are sent by the consulting physicians.

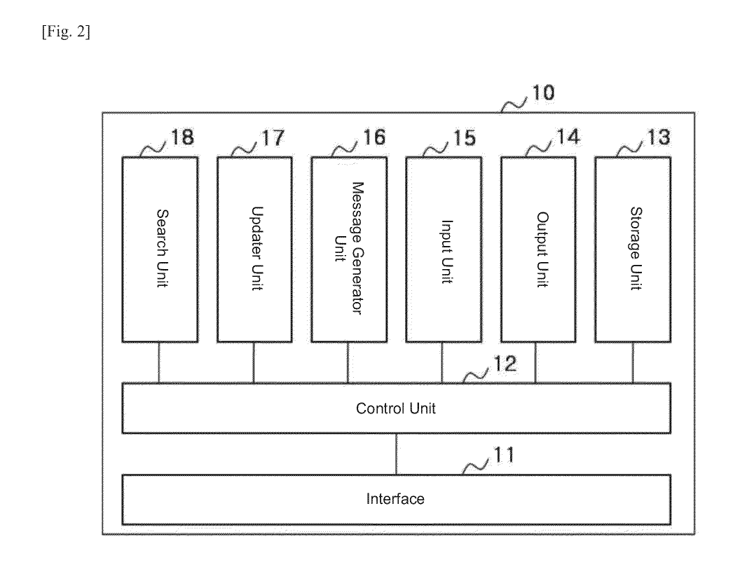

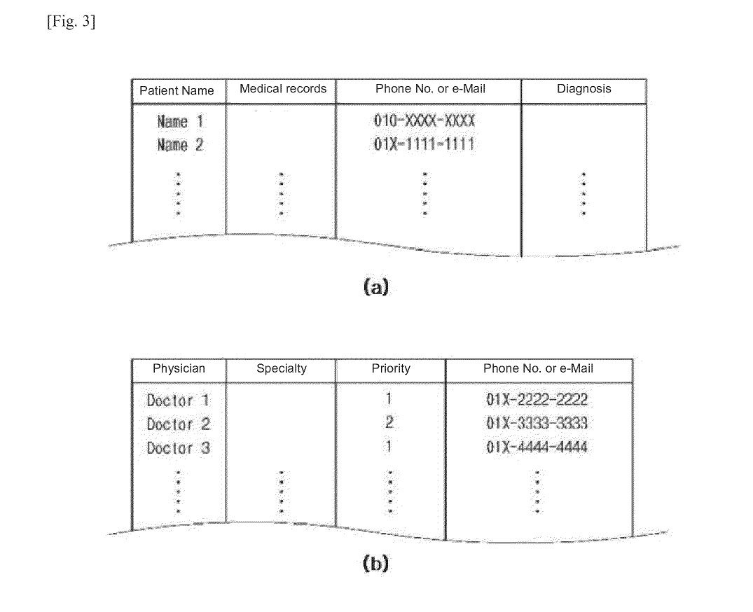

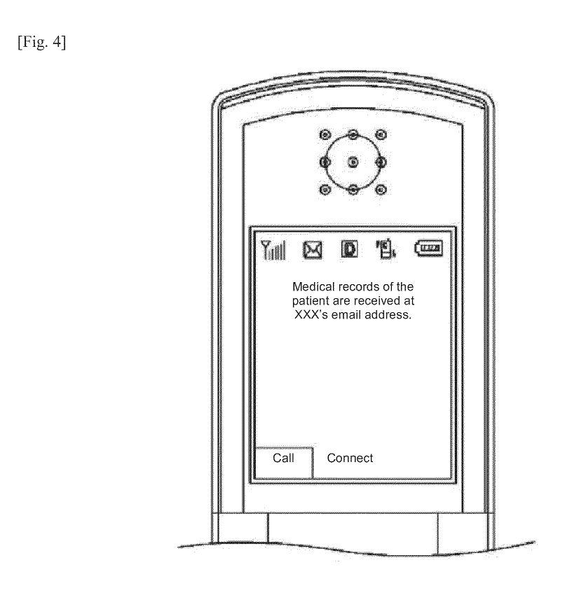

FIG. 2 shows an example of internal configuration of a consultation system designed based on this invention. FIG. 3 is also showing diverse examples of data fields managed by the consultation system based on this invention: (a) shows data fields corresponding to medical records stored in the storage unit of the consultation system; and (b) shows an example of data field for physicians managed by the consultation system. FIG. 4 shows an example of how to request participation in the consultation by using a consultation system based on this invention. It shows an exemplary text message announcing receiving of medical records on a physician's mobile terminal.

As shown in FIG. 2, the consultation system based on this invention may be consisted of an interface 11, a control unit 12, a storage unit (database), an output unit 14, an input unit 15, a message generator unit 16, an updater unit 17 and a search unit 18.

The storage unit (database) 13 will store patient data including medical records and personal data of patients requesting the consultation; diagnosis information concerning medical records; and doctor's information providing diagnosis information generated by analyzing medical records (hereinafter patient information, medical record and diagnosis information are collectively referred to as ‘medical records’). The storage unit will also store information on the client and consulting physicians, consultation schedule, opinions of consulting physicians, consultation data, etc., related to the requested consultation (hereinafter opinions of the client and consulting physicians, consultation schedule, opinions of consulting physicians, and consultation data are collectively referred to as ‘consultation progress information’). Consultation progress information stored in the storage unit will be updated by control unit 12, while medical records and consultation progress information will be mapped each other to store. At this time, it is desirable to codify and encrypt diverse information sent online according to preset rules to protect privacy data of patients while converting to an electronic document format, or block access of people except authorized personnel only. Consultation progress information stored in the storage unit may contain personal data of physicians engaged in the consultation and those of patients (including name, mobile phone number, and e-mail address). The consultation progress information stored in the storage unit may be mapped medical records to relevant patients, while physician information stored in the unit may include specialty, popularity or priority in the branch, number of consultations engaged, number of patient data received, or privacy data (including name, mobile phone number, and e-mail address). Medical records stored in the storage unit may be encrypted; if necessary a portion of data may be encrypted to store. Mobile phone numbers or e-mail addresses of patients or physicians may be used to provide medical records to the consulting physicians or send consulting physician's opinions or consultation information analyzed by a consulting physician directly to other physicians or requesting patients.

Interface 11 will conduct communication between the consultation system 10 and hospital servers, physician terminals or patient terminals. For example, the interface may receive consultation schedule including consultation meeting or consultation time from the consultation doctor and send the related data to relevant consulting physicians; or gather location data from other available consulting physicians to conduct a meeting or consultation to exchange opinions. In here, the interface 210 will send diverse information to relevant consulting physicians via e-mail or text messaging. The interface will also send text messages generated by a message generator unit 16 to relevant mobile terminals, or directly announce it via telephone. For example, if the interface sends text messages or place calls to consulting physicians to request the participation in a consultation, the requested physicians will also receive text messages announcing receipt of medical records of relevant patient via e-mail addresses stored in the storage unit as shown in FIG. 4. The test messages can be set variously.

Search unit 18 will perform searching of information on physicians to engage in the consultation from the storage unit when receiving a consultation request. When a consulting physician is selected and entered by the client, the search unit can be used to search information on the physician directly at the storage unit. If the client does not enter information on a consulting physician, then it will search information on physician to engage in the consultation from data on relevant specialists stored in the storage unit. As shown in FIG. 3(b), when the search unit is looking up data on physician to engage in the consultation, it is possible to select consulting physicians by taking into account their competency data, e.g., priority if necessary in their specific fields, based on data stored in the storage unit. For example, if a patient belongs to Field 1, then the search unit will search the most eligible physician for Field 1; or if priority is considered, then Doctor 1 with the highest priority will be selected. Of course, the search unit can select a consulting physician by taking into account all factors included in the physician information including number of consultations/participations or satisfaction level.

Updater unit 17 will store received information, i.e., medical records and consultation progress information to the storage unit by mapping the data with the consultation system 10 through the interface 11. Even if physician information to manage is added or deleted, the updater unit can update the related information in the storage unit, needless to say.

Message generator unit 16 will generate e-mail documents, text messages or voice messages to be sent to a terminal (hospital terminal or physician terminal) of a consulting physician to engage in the consultation as searched by the search unit 18. The mobile phone number to receive the text messages may be “01X-2222-2222” as stored along with Doctor 1 in FIG. 3(b) for a physician, or “010-XXXX-XXXX” as stored along with Name 1 in FIG. 3(a). The said patient number may be a mobile phone number of Name 1, or mobile phone number of the client who provided the patient information of Name 1.

In addition to the said units, input unit 15 and output unit 14 are conducting entry of diverse data by administrators of the consultation system, or viewing of the data, respectively. Functions of these units may be generally controlled by the control unit.

It is desirable to encrypt all data sending and receiving between terminals (computers/notebooks used by hospital, physician or user) and the consultation system. Such terminals can access to the consultation system via fixed/mobile networks. Likewise, when the consultation system based on this invention receives a request for consultation, it will search physicians to participate in the consultation at the storage unit and send requests for or notification of participation via e-mail, text messaging or other communication means to the selected physicians. The consulting physicians can share data displayed on terminal screen of the client (a doctor in charge, patient or his caretaker) simultaneously and consult each other to diagnose disease in rather short time frame and establish plans for treatment or therapeutic regimen. Thus, this invention can facilitate the lengthy processes engaging residents of client-side, those of consulting physician-side and specialists; reduce errors of physicians, and expedite the progress to the next stage in a timely manner. In this way, it can prevent deterioration of the patient's condition caused by delay, resolve inconveniency of visiting hospitals to consult, save cost for the patient to visit many different clinics and curtail unnecessary waste of time. Furthermore, this invention allows the system send medical records online directly to several consulting physicians concurrently to analyze the data and exchange opinions online in real time. Thus, the system will allow a physician work after office hours to enhance profitability of the physician or his clinic. In addition, it can be used in building an infrastructure which can provide much improved medical services.

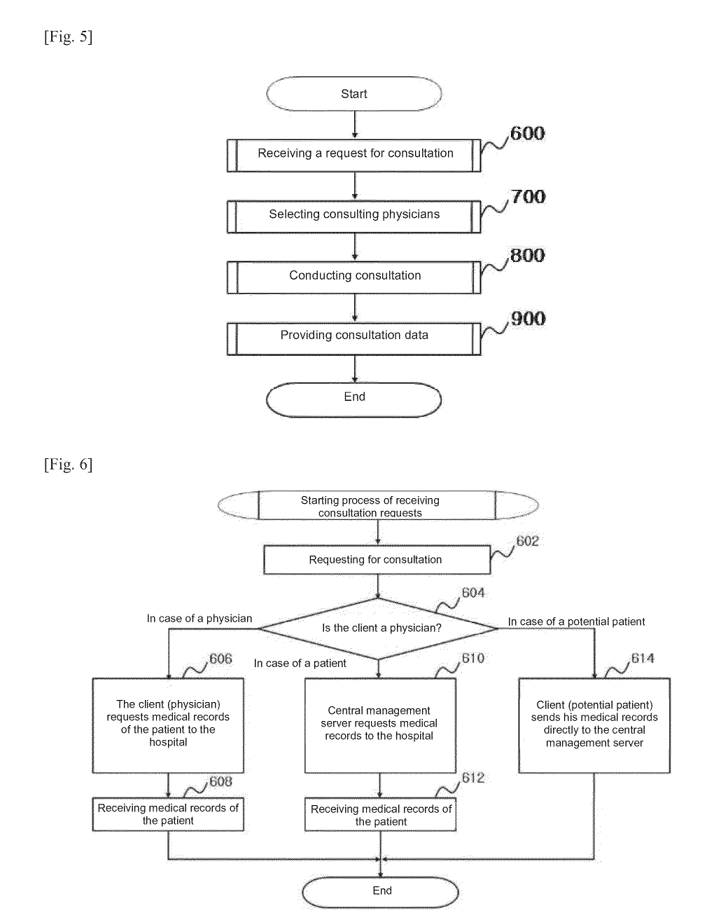

FIG. 5 shows an implementation example of flow chart of the consultation based on this invention.

Consultation method based on this invention starts from receiving a consultation request from a client 600. In here, the client may be a physician taking care of a patient in a specific hospital, or the patient himself who wishes to receive treatment from consulting physicians, or a caretaker of the patient. The following section will describe the process by assuming that a patient and his caretaker are the same, and the client is a physician in charge or a patient in treatment or a patient to receive treatment. In case a client is a patient's caretaker, the process may be the same as the above (though the offered data may be differed somewhat). In other words, if a physician in charge wants to receive support from other physicians, then he may request the consultation by using the consultation system based on this invention; or if a patient receiving treatment at a specific hospital wants to get medical treatment from consulting physicians along with the physician in charge, then he may also request the consultation. In addition, a potential patient who is not yet admitted to a specific clinic for medical care may request the consultation to receive medical treatment from consulting physicians. More details are depicted in FIG. 6.

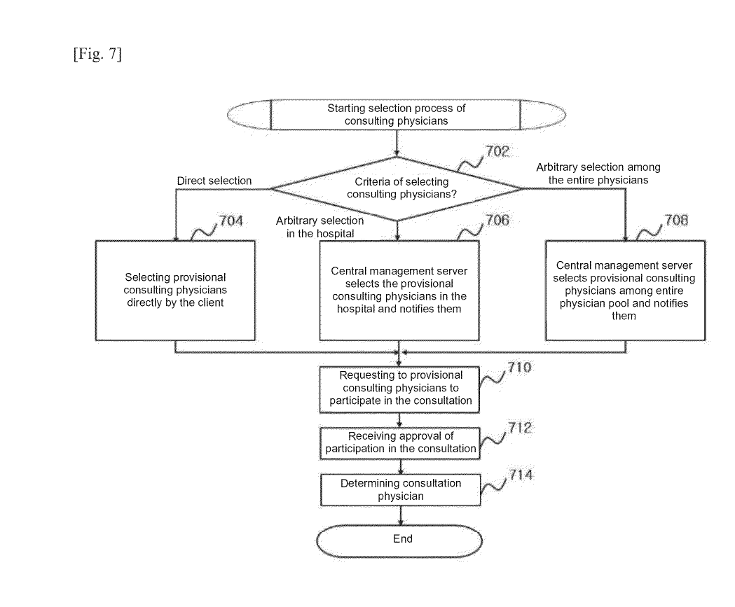

When receiving a request for consultation, the consultation system will select consulting physicians compliant with the request 700. In this case, consulting physicians may be selected among those in the hospital in which the doctor in charge is working, or in other hospitals (including medical schools, research institutes), or in the scope as requested by the client who is patient (i.e., regional or human resource). More details are depicted in FIG. 7.

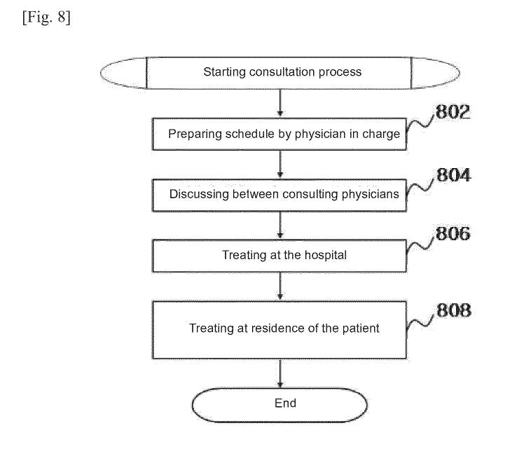

After selecting consulting physicians, the consultation system will receive and manage schedule for consultation, and the consulting physicians will consult the patient according to the schedule 800. That is, if the request recorded in the schedule is that from the client (the doctor) for treatment of a received patient, each consulting physician will prepare his own consulting opinion and send it to the consultation system. If the request in the schedule is that for medical treatment to a patient or for convocation of a meeting, the requested consulting physicians can join the practice or meeting by accessing to the consultation system. If the request in the schedule is that for treatment received by a client (patient), then each consulting physician will access to the consultation system at a designated time, treat the patient concurrently via terminal monitors, and send his own consulting opinion to the consultation system. More details are depicted in FIG. 8.

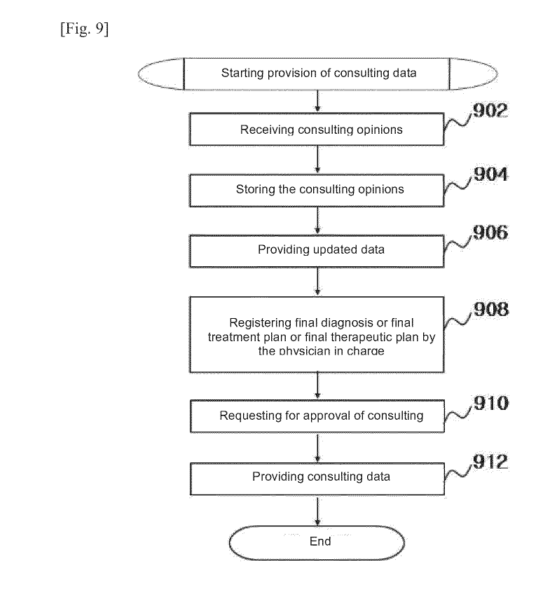

After the physicians conduct consultations pursuant to the said processes and send consulting opinions to the consultation system, the consultation system will store the received information after mapping them to the existing medical records of the patient, and then provide the information to the client by processing it in a format as requested by him. More details are depicted in FIG. 9 (900).

FIG. 6 shows an implementation example of detailed flow of receiving a request for consultation based on this invention, a more detailed version of the process of receiving a consultation request 600 depicted in FIG. 5.

Consultation based on this invention will be initiated after receiving a request for consultation from a client. As mentioned above, the client may be a physician (hereinafter referred to as ‘physician in charge’), or a patient himself, or a potential patient who wants to receive treatment.

First, a client has to subscribe to the consultation system as a member, and then logs in the system to request consultation 602.

When receiving a consultation request, the system will ask whether the client is a physician or a patient 604.

After analyzing the entered information for the said question, if the client is a physician treating a patient, then the system sends a request of medical records of the patient to consult. The client will enter the patient data, for example, name of clinic in which he treats the patient (hereinafter referred to as ‘the hospital’), hospital code and patient data (patient code) into the system 606.

The consultation system will request medical records of the said patient to the hospital according to the data entered by the client, and store the received medical records in the storage unit 608. Such exchange of medical records may be implemented based on a business agreement concluded between the hospital and the consultation system. Another method is that the client will receive medical records of the patient directly from the hospital server, and send them to the consultation system. If the consultation system is installed in the client's hospital, then he can simply enter data of the client and the patient to extract required data from the storage unit of the consultation system. The hospital may send the medical records immediately to the consultation system if requested, but if it has to wait for a certain period of time, the client has to wait for the above-mentioned duration. In such a case, the client may log off the system and then log in it again to check the arrival of the medical records, and then continue the following processes. That is, the consultation system can receive the medical records directly from the client accessed to the system or receive them from a hospital server of a clinic signed a business agreement. The said medical records may include patient data including privacy information, medical history such as treatment options, X-ray data, MRI data, various videos, symptoms, or consulting opinions. They may also include all types of information which can be displayed on hospital terminals, physician terminals and patient terminals including video and voice. In addition, medical records also contain all or part of privacy data of the physician in charge (client) including his contact information such as mobile phone number or e-mail address. After receiving consultation data, the consultation system will store the received medical records in the storage unit (database) S520. When the consultation system will store the medical records in the database depicted in FIG. 3(a), it can extract data pursuant to data fields of the database, and store the data in appropriate fields.

After analyzing the data entered according to the said questions, if it is found out that the client is not a physician, but a patient treated in a specific hospital, then the consultation system will request to the patient for his own medical records. Accordingly, the patient (client) may enter data of the clinic (hereinafter referred to as ‘the hospital’. The hospital may be a hospital in which the physician requesting the consultation is working; or a hospital in which the patient requesting the consultation is being treated) at which he receives treatment at the time (hospital code) and his own data (patient code) into the consultation system. Based on the entered data, the consultation system will request the hospital to send medical records of the patient 610. After receiving the requested data according to the above-mentioned processes 608, the system will store the medical records in the storage unit 612. If the patient manages his own medical records such as X-ray data, MRI data, symptom, opinions opinion, etc., with his patient terminal, then he can send them to the consultation system directly.

If the client is not a physician but a patient who wants to receive treatment soon (hereinafter referred to as “prospective patient”) when analyzing data entered against the said question, the consultation system may request items including privacy data such as age, name gender, and address, or symptoms and details of wanted consultation. The information entered by the prospective patient will be stored in the storage unit as medical records 614.

The consultation system will accept requests for consultation from clients following the said processes, and then select consulting physicians through processes depicted in FIG. 7.

FIG. 7 shows an implementation example of detailed flow of selection process of consulting physicians based on this invention. It is an elaborated version of selection process 700 of consulting physicians depicted in FIG. 5.

When a request for consultation is received and a client is identified through the stage of receiving consultation request 600 as mentioned before, the client will select criteria of selecting consulting physicians from the consultation system 702. That is, the client will directly select consulting physicians by himself or request to select them among practitioners in the hospital at which he is working or being treated, or request to select them among physicians in the entire health care industry including the hospital.

First, when one of items designed to select directly is chosen while medical records of the patient to consult are stored following the said processes 608, 612, and 614, the consultation system may provide the client with a list of all physicians stored and managed in the storage unit. The client may select physicians he wants in the list as provisional consulting physicians 704. Another method available for the consultation system is providing a list of physicians matched to medical records after analyzing them. When the client selects provisional consulting physicians, the consultation system will analyze information on the selected provisional consulting physicians based on their medical records, so it can determine whether the client selects provisional consulting physicians in a rational way (If the client is the physician in charge, the said process may be omitted). If the said analysis reveals that the selection is made in an unreasonable way, the consultation system will notify the client of details of analysis, e.g., requested specialty of the patient does not match with that of a provisional consulting physician, thus allow the client select another provisional physician.

Next, if a client (a patient, a potential patient or a physician in charge) selects an item for arbitrary selection in the hospital while medical records of the patient are stored pursuant to the said processes 608, 612, and 614, then the consultation system will select physicians most suitable for the patient among medical staff in the hospital as provisional consulting physicians, and inform the client of the selection 706. If the client finds an unwanted physician among them, he may request to replace the physician. Then the system will repeat the said process to pick up another physician wanted by the client. In case of a potential patient who has not a designated hospital yet, he may select a clinic in which he wants to receive medical care as the hospital, and request to select consulting physicians in the hospital. If a potential patient does not designate a hospital, or a patient currently receiving medical care at a clinic does not want to select it as the hospital and request to select another hospital arbitrarily, then the consultation system will select the most suitable hospital for the patient based on his personal information (including address), and select provisional consulting physicians in the hospital. For a patient who is already receiving medical treatment in the hospital, if he wants to select another clinic for medical care, then he can select another hospital and choose provisional consulting physicians arbitrarily in the hospital.

Finally, if the client (a patient, a potential patient or a physician in charge) selects physicians arbitrarily in the entire health care industry while medical records of the patient to consult are stored following the said processes 608, 612, and 614, the consultation system will select physicians suitable for the patient among entire physicians registered in the consultation system as provisional consulting physicians, and notify the client of the fact 708. Since processes of settling provisional consulting physicians are identical to that of arbitrary selection in the hospital 706, detailed description will be omitted.

On the other hand, when arbitrary selection or that among entire list is selected 706, 708 among the above-mentioned processes, the consultation system may analyze the received medical records and search data of physicians to conduct the consultation in the storage unit (database). At this time, the consultation system will search data of physicians matching with the specialties included in the medical records at first, and then select physicians to engage in the consultation as provisional consulting physicians. It can be performed by using priority or popularity data stored in the storage unit, while other information such as number of consultations participated, that of treatments among the said participations, satisfaction level of patients, etc., will also be considered in the selection. For example, if the number of participations in consultation of the first physician is ten, that of treatments five and satisfaction level 90 points; while those of the second physician ten, eight and 90 points, respectively; then the second physician may be selected as the provisional consulting physician. On the other hand, if the number of participations of the first physician is ten, that of treatments two and satisfaction level 90 points; while those of the second physician ten, eight and 80 points, respectively; then the second physician may be selected as the provisional consulting physician, since he has the higher number of treatments. Of course, it is obvious that the selection process based on such information can be changed depending on the situation.

The said three processes 704, 706, and 708 may be run independently, though they may be run together. That is, the client can directly designate a specific physician as a provisional consulting physician, though for other physicians he may request arbitrary selection as provisional consulting physicians from the hospital or any other health care institutions. On the other hand, when a provisional consulting physician is selected by the client through the said processes, the consultation system will send a request to the selected physician to participate in the consultation or ask whether to participate in it through e-mail, text message (SMS), ARS (automatically sending a voice message to notify the selection as a provisional consulting physician), telephone call (by an administer of the consultation system directly to the physician) 710. That is, this system can be run regardless of time and place, though it is designed to ask intention of the selected physician as above to avoid any possible conflict of schedule owing to personal issues such as hospitalization, mourning or any other special incident of the physician. The inquiry of participation may be made during a specific time frame, such as one or two days.

If a provisional consulting physician does not indicate his intention to participate during the preset period, or refuse to participate in the consultation via e-mail, text messaging or telephone when requesting to participate in the said consultation, the consultation system will notify the client of the fact and may start a selection process to replace the excluded physician. If all provisional consulting physicians agree to participate in the consultation during the preset period via e-mail or text messaging 712, then the consultation system will notify the client of the fact and match data of the client and the consulting physicians with the medical records and store them to settle the issue 714.

However, if the participation in a consultation is forced pursuant to internal regulations of an organization managing the consultation system such as a hospital or a clinic, then the said request process 710, acceptance process 712, or settlement process 714 may be omitted. In this case, any physician selected as a provisional consulting physician will be finally settled as a consulting physician

On the other hand, if a provisional consulting physician is selected and the consultation system notifies the fact 710, the system may send a consultation schedule including meeting time. In here, a consultation schedule means a series of data required to proceed the consultation, including date and time of video conferencing for consultation, that of video conferencing with the patient for treatment, and so on. The consultation schedule may be send to e-mail addresses or various contactable terminals, which may include entire or a part of the medical records. On the other hand, if a message sent by the consultation system to request the participation in the consultation is simply a message of informing the selection as a provisional consulting physician, then the physician receiving the message may access the consultation system, review details of the consultation schedule/medical records, and notify his intention of participating in the consultation to the system.

FIG. 8 shows an implementation example of detailed flow of consultation processes based on this invention, which shows the consultation process 800 depicted in FIG. 5 in detail.

When consulting physicians are selected through the said processes, the consultation system will select a doctor in charge among the selected consulting physicians and notify the client and each consulting physician of the fact. At this time, the doctor in charge may make a consultation schedule and register it on the consultation system 802. The doctor in charge may be selected directly by the client among consulting physicians, or selected arbitrarily by the consultation system. If the client is the physician in charge of the patient and does not want to select additional doctor in charge, then it is possible to appoint him as the doctor. That is, if the client is a patient or a physician in charge, and he does not express any special intention, then the consultation system may select him as the doctor in charge. The consulting physician selected as the doctor in charge may prepare a consultation schedule and register it on the consultation system, which will share the schedule with other consulting physicians. Although a consultation schedule is described as capable of sending while notifying the participation in consultation, the schedule sent with the notice will be prepared arbitrarily by the client as a reference in selecting consulting physician. When the consulting physicians and the doctor in charge are settled, the doctor will make a final version of the consultation schedule and register it on the consultation system. In addition, the doctor in charge will be selected to coordinate communication among consulting physician and prepare the final consultation information. Thus, in most cases, the doctor will be selected among consulting physicians of the hospital at which the patient will visit and be treated. However, if such visit of the patient is not obligatory, then the doctor may be selected arbitrarily.

On the other hand, the consulting physicians may analyze medical records managed by the consultation system, or coordinate consulting opinions via video conferencing by accessing to the system at a designated time according to the consultation schedule, or watch seminars conducted the doctor in charge or a consulting physician, or monitor the status of medical treatment of the patient by the doctor 804. That is, the consulting physicians can share medical records managed by the consultation system, or exchange opinions each other via video conference, teleconference, e-mail, or text messaging at a designated time pursuant to the consultation schedule to determine the most appropriate medical treatment for the patient.

The consulting physicians will analyze the medical records managed by the consultation system, and if the patient visits the hospital according to the preset schedule, then they monitor treatment of the patient via their terminals to check the patient's status 806.

If the patient does not visit the hospital according to the consultation schedule but accesses the consultation system via his terminal, then the consulting physicians will try to consult with the patient via hospital terminals or their individual physician terminals to inquire his symptoms or observe the status of the patient, or make him to conduct some diagnostic activities by himself, such as pressing a specific part of his body by himself or pointing his camera to his neck or eyes, or order him to make sound 808.

As mentioned above, this invention allow consulting physician conduct effective medical care activities whether the patient visits the hospital 806 or stays at his home by performing medical treatments via video conferencing 808, sharing medical records (including photos (X-ray, MRI, etc.), various results of tests and physical therapy, etc.) registered on the consultation system by the doctor in charge (or transmitted to the system by the hospital automatically) with other consulting physicians, exchanging opinions among consulting physicians by registering them on the consultation system, and holding meetings via video conferencing to listen to explanation of others or exchange opinions 804. The consultation system offers sharing of terminal screens between consultation physicians and the client after proper authentication. It also allows sharing of a screen of the client or the doctor in charge with the entire consulting physicians (a view showing medical record or treatment of the patient). It is also possible for a consulting physician to share his screen view to present his opinion or display medical data. Thus, consulting physicians separated geographically can share all the details displayed on each other's terminal screen while exchanging opinions.

FIG. 9 shows an implementation example of detailed flow of providing consultation information based on this invention. It is a detailed version of a process of providing consultation information 900 as depicted in FIG. 5.

While conducting the said consultation process 800, each consulting physician will be able to analyze various medical records and send his opinion to the consultation system 902, which will match the received opinions with the medical records and store them 904.

The consultation system can also send a text message notifying update of medical records or consultant's opinions by calling mobile terminals of the client and the consulting physicians included in consultation progress information or via e-mail 906. In this case, if a message of notifying the storage of updated information on the consultation system is sent via text messaging or e-mail, then the client or the consulting physicians receiving such a message will access to the consultation system with his terminal, log in the system and check the details. That is, in case of urgent consultation, it is possible to gather opinions once, and then the doctor in charge or the client may conduct the diagnosis/treatment of the patient. However, if continual consultations are required, then medical records of the patient may be altered/updated owing to repeated applications of medical treatments such as physical therapies, drug deliveries, or X-ray; and opinions of the consulting physicians may be revised incessantly. Even in such cases, the system can notify the availability of updated information immediately, so the consultation on the patient can be made in a timely and accurate manner.

In addition, the doctor in charge or the client can compile and register all the consultation data such as final results of diagnosis, final treatment plan or final therapeutic plan, to the consultation system after receiving opinions of individual consulting physicians 908. That is, since ultimate goal of the consultation is the medical treatment of the patient, the doctor in charge or the client will compile diverse opinions of consulting physicians and use the data in treating the patient effectively. Such consultation data may be registered for just one time, though for a patient who needs to conduct long-term treatment, the data may be registered repetitively periodically or when necessary.

The doctor in charge may upload the consultation data such as final result of diagnosis or therapeutic plan on the consultation system, and request final approvals of all the other consulting physicians. In this case, the consultation system may send the said request to all the consulting physicians, and then gather the opinions to send them to the doctor in charge 910. If the doctor in charge believes that there is an error in the final results of diagnosis or the final treatment plan, he may repeat the said process of requesting the approval. That is, the consultation process is requested to treat the patient, and the doctor in charge or the client will be able to treat the patient based on the consultation, so it is desirable to ask opinions of all the consulting physicians once again at the final treatment stage to conduct the treatment more reliably. However, such request for approval of consultation data may be omitted.

Finally, the doctor in charge will use the consultation data such as final results of diagnosis or final treatment plan. If the client is a potential patient, then there will be no additional medical treatment, so the doctor may register the consultation data on the consultation system for the patient to check 912. If the physician in charge of treating the patient and the doctor are different, then the doctor will register the finally approved consultation data to the consultation system, so the physician in charge can use the data in treating the patient. In addition, the consultation system will send the data registered by the client or the doctor to the potential patient or the patient via mail, etc., or notify the registration of data, so the potential patient or the patient can receive proper treatment; if medication treatment is possible, then it is possible to provide the medication data concurrently.

As mentioned above, this invention is on the consultation services for patients. Whether a physician is directly participating in treatment of a patient or not, it allows every physician to analyze patient data or exchange his opinion in real time, while viewing the data together or separately regardless his location.

In addition, this invention allows the minimization of time frame required to establish treatment plans for patients or make decisions on medical diagnosis or treatments. Since this invention can provide circumstances identical to real meetings between physicians located in different places regardless of time and place, it will be able to offer the best medical care services and the highest level of efficiency; thus, the quality of medical services provided by individual medical institutions will be upgraded to the highest level. That is, this invention will be able to provide patient data in real time to individual physicians, even if they are separated in any places around the world. In this way, they can get the support of the best available specialists and provide the timely decision-makings and professional opinions for the benefits of patient. Also, medical institutions can select a very efficient method to get the same result; they can gather considerable profits in terms of medical treatment, human resources, equipment/facilities or economy.

In addition, with this invention, it is possible to convene the best medical specialists scattered in a hospital, in a region or across the world at the same time, if necessary to get consultation. They can view various medical records (such as photos, video or diverse medical documents or references) in real time simultaneously by using different devices, and exchange opinions. Through the above-mentioned processes, this invention allows physicians exchange opinions, make diagnosis, establish treatment plans, or make decisions, all of which have been difficult or impossible if each specialist exists in the same place. In addition, it is possible for physicians to eliminate inconvenience of terminating on-going works and moving to a meeting place to conduct the said operations. Also, this invention allows patients to relieve inconvenience of visiting different clinics or waiting their turns to meet individual specialists directly.

With this invention, it is possible for a patient to share his medical records including diagnosis of his disease or consulting opinions between physicians without a need of visiting different hospitals. In this way, the patient can minimize the time period to diagnose his disease and get high quality medical services. Until now, if it is difficult to diagnose a disease at a private clinic, then a patient has to visit a larger hospital to get proper medical treatments. In such a case, the patient has to go through all the required procedures once again, which required additional copies of his medical records along with extra time and money. The patient also feels a sense of anxiety on his disease during the time. However, with this invention, the patient can get his medical care and check the result of diagnosis in a timely and efficient way.

The said description shows expected examples of implementation of this invention along with diagrams. The application of this invention will not be limited by the said examples. Without exceeding the summary of this invention as demanded by the scope of a patent request, anybody with conventional knowledge on the technical fields in which this invention belongs can modify and implement this invention in various ways, and such modification will reside in the description of the scope of a patent request.

1. A system for medical treatment with consultation, comprising:
a storage unit to store medical records related to a patient requesting consultation, data on physicians to participate in the consultation, and consultation progress information gathered following the progress of consultation performed according to the said request;
an interface to communicate with at least one of the following devices: hospital servers, hospital terminals, physician terminals, or patient terminals linked via network;
a search unit to select consulting physicians to engage in the said consultation pursuant to the said request, when receiving the request from one of the following devices: the hospital terminals, the physician terminals, and the patient terminals mentioned above; and
a control unit which controls the storage unit, the interface, and the search unit to store the said consultation progress information in the said storage unit, wherein when the said consultation request is received from one of said hospital terminal, physician terminal and patient terminal, said control unit drives the said search unit to select at least one consulting physician to engage in the said consultation, exchanges data via video conferencing with terminals used by said consulting physicians pursuant to preset schedule, and provides the gathered consultation progress information through said exchange to at least one of said hospital servers, said hospital terminals, said physician terminals, and said patient terminals.

2. A system for medical treatment with consultation according to claim 1, further comprising an updater unit which updates said medical records or consultation progress information, when an update information for said medical records or consultation progress information is received, wherein said updater unit is driven by the control unit when the control unit receives said update information while implementing consultation according to said consultation request.

3. A system for medical treatment with consultation according to claim 1, further comprising a message generator unit which generates a message for consultation request to be forwarded to a provisional client selected from the physician data when the consultation requested is received, or a message for consultation schedule related to said consultation progress information to be forwarded to a selected provisional consulting physicians according to said consultation request, wherein said control unit forwards the message generated by said message generator unit to one of the hospital terminals, the physician terminals, or the patient terminals.

4. A method for medical treatment with consultation, the method comprising the steps of:
receiving a consultation request from at least one of hospital terminals, physician terminals, and patient terminals by the system for medical treatment with consultation; selecting at least more than one consulting physicians to engage in the consultation pursuant to said consultation request;
providing medical records of patients to said consulting physicians when receiving said medical records of patients from at least one of the hospital server of the designated hospital, hospital terminals, physician terminals, and patient terminals according to said consultation request, and conducting the consultation according to a consultation schedule registered for said consultation by controlling communications among the hospital terminals, physician terminals, and patient terminals; and
transmitting the consultation progress information including said consultation schedule, consulting opinions received from the said consulting physicians, and consultation data registered according to said consulting opinions to at least one of the hospital terminals, physician terminals, and patient terminal.

5. The method for medical treatment with consultation according to claim 4, wherein the step of receiving said consultation request comprises the steps of:
determining whether a client making said request is a physician when receiving a request of consultation;
requesting said client to send medical records of a patient subject to the said consultation when the said client is turned out as a physician from the determining step, receiving said medical records from the hospital terminal, the physician terminal used by said client, or said hospital server selected by said client, and storing the medical records; and
requesting said patient as client to send medical records of a patient when the client is turned out as a patient from the determining step, receiving said medical records from the patient terminal used by said client, or from a hospital server selected by said patient as client, and storing the medical records.

6. The method for medical treatment with consultation according to claim 5, further comprising requesting said patient as client to send medical records of a patient when the client is turned out as a potential patient from the determining step, receiving said medical records from the patient terminal used by said client, and storing the medical records.

7. The method for medical treatment with consultation according to claim 4, wherein the step of selecting said consulting physicians comprises the steps of:
inputting selection criteria of consulting physicians by the consulting client providing physician data stored therein when the selection criteria is direct selection, and selecting physicians chosen by said client among the stored data of physicians as consulting physicians; and
selecting at least one physician among the stored data of physicians as a consulting physician when the selection criteria is arbitrary selection.

8. The method for medical treatment with consultation according to claim 7, wherein the arbitrary selection is to select at least one physician as the consulting physician among physicians in the hospital where client is receiving or providing medical treatment, or to select at least one consulting physician as said consulting physician among physicians excluding those working for said hospital.

9. The method for medical treatment with consultation according to claim 4, wherein the step of conducting the consultation comprises the steps of:
providing the medical records of a patient to said consulting physicians; and
transmitting video, voice or document files among said physician terminals and hospital terminals by controlling communications between the physician terminals and hospital terminals.

10. The method for medical treatment with consultation according to claim 4, wherein the step of transmitting said consultation progress information comprises the steps of:
receiving and maintaining the consulting opinions from the hospital terminals or physician terminals used by said consulting physicians; and
transmitting the consultation data including final diagnosis or final treatment results or final therapeutic plan generated according to said consulting opinions to at least one of the hospital terminals, physician terminals, or patient terminals.

11. A system for medical treatment with consultation according to claim 2, further comprising a message generator unit which generates a message for consultation request to be forwarded to a provisional client selected from the physician data when the consultation requested is received, or a message for consultation schedule related to said consultation progress information to be forwarded to a selected provisional consulting physicians according to said consultation request, wherein said control unit forwards the message generated by said message generator unit to one of the hospital terminals, the physician terminals, or the patient terminals.
